(19) United States
(12) Patent Application Publication
(10) Pub. No.: US 2015/0312482 A1
(43) Pub. Date: Oct. 29, 2015

(54) USER INPUT TECHNIQUE FOR ADJUSTING SUCCESSIVE IMAGE CAPTURING

(71) Applicant: YouLapse Oy, Helsinki (FI)

(72) Inventors: Antti TUOMAALA, HELSINKI (FI); Antti AUTIONIEMI, HELSINKI (FI)

(73) Assignee: YouLapse Oy, Helsinki (FI)

(21) Appl. No.: 14/263,036

(22) Filed: Apr. 28, 2014

(51) Int. Cl. H04N 5/232; G06F 3/0488; G06F 3/0484; G06F 3/01; G06F 3/041

(52) U.S. Cl. CPC H04N 5/23293; G06F 3/017; G06F 3/0416; H04N 5/23245; G06F 3/04842; G06F 3/0488

(57) ABSTRACT

An electronic device, includes: a touch screen, a digital camera, a computing entity configured to display graphical user interface via the touch screen, and configured to capture user input via the graphical user interface, and configured to utilize digital camera for digital imaging, the computing entity being specifically configured to: initiate a successive image capturing function via the digital camera, detect substantially continuous user input gesture via the graphical user interface, optionally upon graphical indications, and adjust the capture rate of the successive image capturing function according to the user input gesture. A corresponding method is presented.

### FIELD OF THE INVENTION

Generally the present invention concerns digital imaging. Particularly, however not exclusively, the invention pertains to a method for adjusting successive imaging capture rate during imaging via user input gestures.

### BACKGROUND

Taking images and video with digital camera devices such as smartphones, tablets and digital single-lens reflex cameras (DSLRs) has become tremendously popular. This is partly due to the fact that the attainable video and image quality are generally high even in the majority of the more affordable devices, which offers consumers an easy way to get into photography.

Further on, the associated imaging functions have increased in numbers and the related imaging techniques such as burst mode and slow motion imaging have become available in many non-professional consumer electronics. However, shifting between taking photographs and capturing video during successive imaging hasn't been solved.

Even further, adjusting imaging functions such as successive image capture rate is arduous and requires manual labor between imaging inefficiently by changing settings while not imaging. Hence, a user cannot successfully commence imaging without taking the presets or prevailing settings into consideration. In general, settings need to be set differently on a case-by-case basis, which means that attaining instant imaging and good settings according to the prevailing conditions is not efficient with present solutions. Even more, adjusting settings should be intuitive and effortless so that it doesn't distract the imaging itself.

This is especially inconvenient since many a time moment worth capturing cannot be reproduced and imaging opportunities are easily lost. Evidently, users would gain from being able to start imaging instantly when they wish to do so without having to worry if the adjustments are suitable at the time.

### SUMMARY OF THE INVENTION

The objective of the embodiment of the present invention is to at least alleviate one or more of the aforesaid drawbacks evident in the prior art arrangements particularly in the context of adjusting successive digital imaging. The objective is generally achieved with the present invention by having a device capable of imaging and receiving input via touch screen to adjust said imaging, and a method for adjusting the imaging functions according to the received user input during imaging.

One of the advantageous features of the present invention is that it enables a user to adjust capture rate of successive digital imaging by simple and intuitive gestures and input techniques. Further on, giving user input and visualizing parameters and controls related to the user input are enabled. Even further, the invention enables not just the adjustment of capture rate but also other features and functions, optionally related to the capture rate, via the technique according to the present invention.

Another one of the advantageous features of the present invention is that it allows a digital imaging device to change modes during successive imaging from recording digital image files to recording digital video. The user may so choose during imaging if they want to change, for example, between capturing digital images, digital video and digital slow motion video, in accordance to the rate of capture controlled by the user.

In accordance with one aspect of the present invention an electronic device, comprising:
a touch screen,
a digital camera,
a computing entity configured to display graphical user interface (GUI) via said touch screen, and configured to capture user input via said graphical user interface, and configured to utilize digital camera for digital imaging, the computing entity being specifically configured to:
   initiate a successive image capturing function via said digital camera;
   detect substantially continuous user input gesture via said graphical user interface, optionally upon graphical indications;
   adjust the capture rate of said successive image capturing function according to said user input gesture.

According to an exemplary embodiment of the present invention the successive image capturing is a burst mode function. The successive image capturing may have an initial capture rate of substantially 3 frames per second or 4, 6, 8 or 10 frames per second, or basically any other technically feasible number of frames per second. According to an exemplary embodiment the capture rate adjustment may comprise increasing or decreasing the capture rate essentially continuously. According to an exemplary embodiment of the present invention the capture rate of successive image capturing may comprise a capture rate of 1-10 frames per second, more than 10 frames per second and/or less than 1 frame per second. For example, the successive image capturing may so comprise capturing a number of images per second and/or capturing less than one image in second, so that the imaging function is ongoing but captures images with an interval (between the images) of higher than 1 second.

According to an exemplary embodiment of the present invention the computing entity is configured to shift from successive image capturing to capturing video at a predetermined capture rate. The capture rate may be predefined, optionally according to user input. The predetermined capture rate may be substantially e.g. 10 frames per second or 12, 14, 16, 18, 20, 22, 24 or e.g. 30 frames per second, or basically any other technically feasible number of frames per second. Optionally the computing entity may be configured to inquire if the user would like to shift from successive image capturing to capturing video, optionally graphically and/or textually.

According to an exemplary embodiment of the present invention the user input may be engendered by means, such as one or more fingers, another similarly suitable anatomical part and/or by a stylus, for example.

According to an exemplary embodiment of the present invention the user input gesture may comprise essentially horizontally, vertically and/or circularly introduced free movement upon the touch screen, optionally upon graphical indications. Typically, when the user input gesture is provided via touch screen, the gesture is provided relative to a two-dimensional plane defined by the touch surface of the touch screen. The user input gesture may comprise lines and curves with any shapes, such as arcs and curves with multidirectional paths, said curves being optionally closed. The user input gesture may be substantially continuous, which means the user input may be engendered statically on a location and/or by moving on the touch surface. Hence, both two-dimensional and three-dimensional touch screens may allow for the user input gesture to be generated by moving two-dimensionally in relation to the touch screen and/or by moving essentially perpendicularly against the touch screen. In any case, the capability, extent and especially the accuracy to translate pressure or three-dimensional movement essentially perpendicular to the touch screen depends on the touch screen technology, i.e. the sensors and their substrate/housing material in which they are integrated.

Additionally or alternatively, the pace of the gesture may change from astatic state to a relatively rapid movement, and various different paces in between. Beginning or end of a gesture may be detected, for example, from a rapid introduction or loss of pressure, or generally input means, respectively on a touch-sensitive surface.

According to an exemplary embodiment of the present invention the graphical indications may comprise any graphics such as circular and/or line graphics, optionally representing indicators and/or other visualizations e.g. of a meter or gauge showing the measure of the adjustable parameter and/or of a control device such as a slide (knob), a (rotary) control knob, a push knob, a curve slide (knob) or a lever. Such meters and control devices may so be used for visualization purposes for making it easier for a user to adjust features and monitor their real time values while imaging. Further on, such graphical user interface visualizations may comprise indicators and/or control devices analogous with common hardware indicators and control devices that respond and are usable by input means in the same manner as their analogous hardware counterparts. For example, a GUI control knob (virtual knob rendered on the display) may be turned via a user gesture and it may also represent the value via a scale around the knob, wherein the degree of rotation would correspond to the desired input and/or adjustment. Hence, any such control device means and indicators may be graphically visualized and used together with the present invention.

According to an exemplary embodiment of the present invention the graphical indications may comprise visualizing the area or the path along which the input gesture may be engendered, optionally graphically and/or textually. The graphical and/or textual visualization may comprise tagging, highlighting, outlining, coloring, text or a number of letters, numbers, alphanumeric markings, and/or the graphical indications, e.g. curves or lines, and/or other markings of the area or path.

According to an exemplary embodiment of the present invention the touch screen comprises a two-dimensional or essentially three-dimensional, optionally contactless, user interface. Examples of such user interfaces comprise camera-based, capacitive, infrared, optical, resistive, strain gauge and surface acoustic wave touch screens.

According to an exemplary embodiment of the present invention the user input gesture, optionally the same as used for capture rate adjustment, may be optionally used to adjust also other imaging features and/or shifting between modes such as exposure, aperture, focusing, light metering and/or white balance functions. In particular, this may be used to adjust said imaging features so that their parameters change in relation to the capture rate, which enables a more even quality when shifting between different frame rates and image and video capturing modes.

According to an exemplary embodiment of the present invention capturing video may comprise recording digital video and/or recording e.g. slow-motion video of high capture rate. Changing from regular video mode to slow-motion recording mode may be done substantially at and over 24 frames per second higher. Many commonly used digital cameras allow for capturing slow-motion video up to 120 frames per second capture rate and over, which may be also feasible for the present invention.

According to an exemplary embodiment of the present invention the electronic device may comprise or constitute a mobile terminal or ‘smartphone’, a tablet computer, a phablet computer, a digital camera, such as an add-on, time-lapse, compact, DSLR, DSLT or high-definition personal camera, or a desktop terminal.

According to an exemplary embodiment of the present invention the computing entity is configured to save the captured image and/or video entities in the device's memory entity or another memory entity such as a remote server or a cloud computing entity, wherefrom they may be accessible and displayable via a plurality of different devices, such as mobile and desktop devices.

In accordance with one aspect of the present invention a method for adjusting the capture rate of said successive imaging through an electronic device, comprising:
receiving substantially continuous user input provided as a gesture on a graphical user interface via the touch screen,
detecting the movement direction and magnitude of the user input gesture,
adjusting the speed of the successive imaging function according to the direction and magnitude of the user input gesture.

According to an exemplary embodiment of the present invention the capture rate of the successive imaging function is at a predetermined value at the initial state of the method, wherein said value may be chosen by the user.

According to an exemplary embodiment of the present invention the movement direction of the user input gesture is translated to an increasing or decreasing action of a parameter value, wherein the magnitude, i.e. the length or duration, of the user input gesture in a direction is translated as the according change of the parameter value. For example, turning a knob clockwise may produce an increase in the capture rate. Following the same example, the rotation may be scaled so that a one step, for example if the rotation of the knob is divided into ten steps, may produce a change in rate of capture of 1 frame per second, or 2, 4, 6 or 8 frames per second. Optionally the scale may be divided so that it comprises the whole possible range in which the rate of capture may be changed, such as for example dividing the rotation scale evenly so that the rate of capture may be changed from less than 1 frames per second to 120 frames per second. Optionally the scale may be divided so that it comprises the whole possible range in which the rate of capture may be changed, but such as that the rotation scale is divided unevenly optionally so that the lower rates are less sensitive (scale is wider in the beginning), which makes it easier to change smaller frame rates with greater accuracy, said smaller frame rates being for example from less than 1 frames per second to 24 frames per second. Correspondingly, similar scaling and direction-magnitude technique may be used with other graphical indications and GUI control devices. For example, a slide may produce an increase in capture rate when moved to the right and vice versa. Using the same example, the slide may have a visualizing indicator such as a bar or a gauge that indicates the whole scale of possible capture rates. Both indicators and graphical control devices are merely exemplary but they propose beneficial embodiments from the viewpoint of usability as both of them are usable with for example one finger.

According to an exemplary embodiment of the present invention the user input gesture may follow the graphical indications or at least be determined in relation to the graphical indications. For example, when a number of graphical indications are used the user input gesture may be engendered essentially upon them or optionally on another location of active touch surface area, wherein the movement may be translated in relation to the used graphical indication(s). For example, a touch may be engendered on a slide as to grab and drag the slide. Optionally, for example a touch may be engendered on another location of the touch screen wherefrom the pointing and movement are translated as the grabbing and dragging of the slide preferably the according to the essentially same moving direction relative to the slide. Accordingly the user input gesture may change directions during the gesture, which inter alia allows for switching between increasing and decreasing of capture by moving an input means back and forth along the graphical indication. This is important, although not mandatory, from the perspective of adjusting capture rate with accuracy.

In accordance with one aspect of the present invention a computer program product embodied in a non-transitory computer readable medium, comprising computer code for causing the computer to execute:
receiving substantially continuous user input provided as a gesture on a graphical user interface via the touch screen,
detecting the movement direction and magnitude of the user input gesture,
adjusting the speed of the successive imaging function according to the direction and magnitude of the user input gesture.

According to an embodiment of the present invention the computer program product may be offered as a software as a service (SaaS).

Different considerations concerning the various embodiments of the electronic arrangement may be flexibly applied to the embodiments of the method mutatis mutandis and vice versa, as being appreciated by a skilled person.

As briefly reviewed hereinbefore, the utility of the different aspects of the present invention arises from a plurality of issues depending on each particular embodiment.

The expression “a number of” may herein refer to any positive integer starting from one (1). The expression “a plurality of” may refer to any positive integer starting from two (2), respectively.

The terms “rate of capture”, “capture rate” and “frame rate”, i.e. the pace/rate/frequency at which an imaging device produces unique consecutive images/frames, are used interchangeably and are meant as being equivalent in connotation.

The term “exemplary” refers herein to an example or an example-like feature, not the sole or only preferable option.

Different embodiments of the present invention are also disclosed in the attached dependent claims.

### BRIEF DESCRIPTION OF THE RELATED DRAWINGS

Next, the embodiments of the present invention are more closely reviewed with reference to the attached drawings, wherein

FIG. 1 is a block diagram of one embodiment of an electronic device comprising entities in accordance with the present invention.

FIG. 2 illustrates exemplary configurations of graphical indications and user input gestures of an embodiment of an electronic device in accordance with the present invention.

FIG. 3 is a flow diagram of an embodiment of a method for adjusting capture rate of successive imaging function through an electronic device in accordance with the present invention.

### DETAILED DESCRIPTION OF THE EMBODIMENTS

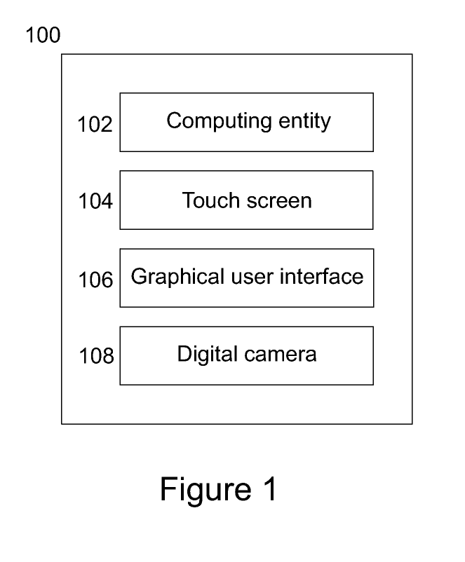

With reference to FIG. 1, a block diagram of one embodiment of an electronic device 100 in accordance with the present invention is shown.

The electronic device 100 comprises essentially at least a computing entity 102, a touch screen 104, a graphical user interface 106 and a digital camera 108.

The computing entity 102 is essentially configured to at least display a graphical user interface 106 via said touch screen 104, capture user input via said graphical user interface 106 and utilize a number of digital cameras 108 for digital imaging. Further on, the computing entity 102 is specifically configured to initiate a successive image capturing function via said digital camera 108, detect substantially continuous user input gesture via the graphical user interface 106, optionally upon graphical indications, and adjust the capture rate of said successive image capturing function according to said user input gesture.

The computing entity 102 comprises, e.g. at least one processing/controlling unit such as a microprocessor, a digital signal processor (DSP), a digital signal controller (DSC), a micro-controller or programmable logic chip(s), optionally comprising a plurality of co-operating or parallel (sub-)units.

The computing entity 102 is further on connected or integrated with a memory entity, which may be divided between one or more physical memory chips and/or cards. The memory entity is used for example to store images and other content. The memory entity may further on comprise necessary code, e.g. in a form of a computer program/application, for enabling the control and operation of the electronic device 100 and the GUI 106 of the device 100, and provision of the related control data. The memory entity may comprise e.g. ROM (read only memory) or RAM-type (random access memory) implementations as disk storage or flash storage. The memory entity may further comprise an advantageously detachable memory card/stick, a floppy disc, an optical disc, such as a CD-ROM, or a fixed/removable hard drive.

Optionally the captured image and video files may be saved to a memory entity external to the device 100 such as a remote server or a cloud computing entity, wherefrom they may be accessible and displayable via the device 100 and optionally a number of different devices, such as mobile and desktop devices.

The touch screen 104 may be comprise a number of different touch screen types such as are essentially touch-based, contactless and/or three-dimensional touch screens via which a user may give input to the device 100. Some exemplary feasible touch screens comprise camera-based, capacitive, infrared, optical, resistive, strain gauge and surface acoustic wave touch screens.

The graphical user interface 106 is essentially device-dependent. The graphical user interface 106 may be used to give commands and control the software program. The graphical user interface 106 may be configured to visualize, or present as textual, different data elements, status information, control features, user instructions, user input indicators, etc. to the user via for example the touch screen 104.

The digital camera 108 is chosen from the plurality of digital imaging devices capable of at least creating digital images and optionally additionally digital video. Further on, the digital camera 108 comprises the capabilities for capturing a number of photographs in quick succession, such as a ‘burst’ or ‘rapid fire’ mode, and optionally the capabilities to overcrank, i.e. to record slow-motion video via recording video with a high frame rate or via high-speed photography. Said feasible digital cameras may comprise integrable camera modules and other digital cameras, optionally with fixed or adjustable optics.

The captured images may comprise digital image files, such as photograph, still image, layered image and/or other graphics files. The digital image file formats may comprise formats known to a person skilled in the art, the format being selectable and resulting according to the digital camera 108 and computing entity 102 configurations.

The captured video may comprise various multimedia container formats known to a person skilled in the art, the formats being selectable and resulting according to the digital camera 108 and computing entity 102 configurations.

The device 100 comprises optionally also the housing elements and means and fastening/attachment means and entities as well as other additional elements known to a person skilled in the art for integrating the computing entity 102, touch screen 104, graphical user interface 106 and digital camera 108 together, optionally with supporting devices and components such as conducting and power supply elements. The electronic device 100 may so comprise or constitute a mobile terminal or ‘smartphone’, a tablet computer, a phablet computer, a digital camera, such as an add-on, time-lapse, compact, DSLR, DSLT or high-definition personal camera, or a desktop terminal.

As an example, the elements may be electronic, electro-optic, electroacoustic, piezoelectric, electric, and/or electromechanical by nature, or at least comprise such components. Further on, such components may comprise tactile components and/or vibration elements such as piezoelectric actuators or vibration motors, light-emitting components such as (O)LEDs, light blocking elements or structures, sound-emitting and or sound-receiving such as microphones and speakers, cameras, conductors, wires, fastening means and encasing(s). As being appreciated by skilled readers, the configuration of the disclosed components may differ from the explicitly depicted one depending on the requirements of each intended use scenario and selected user interface technologies, wherein the present invention may be capitalized.

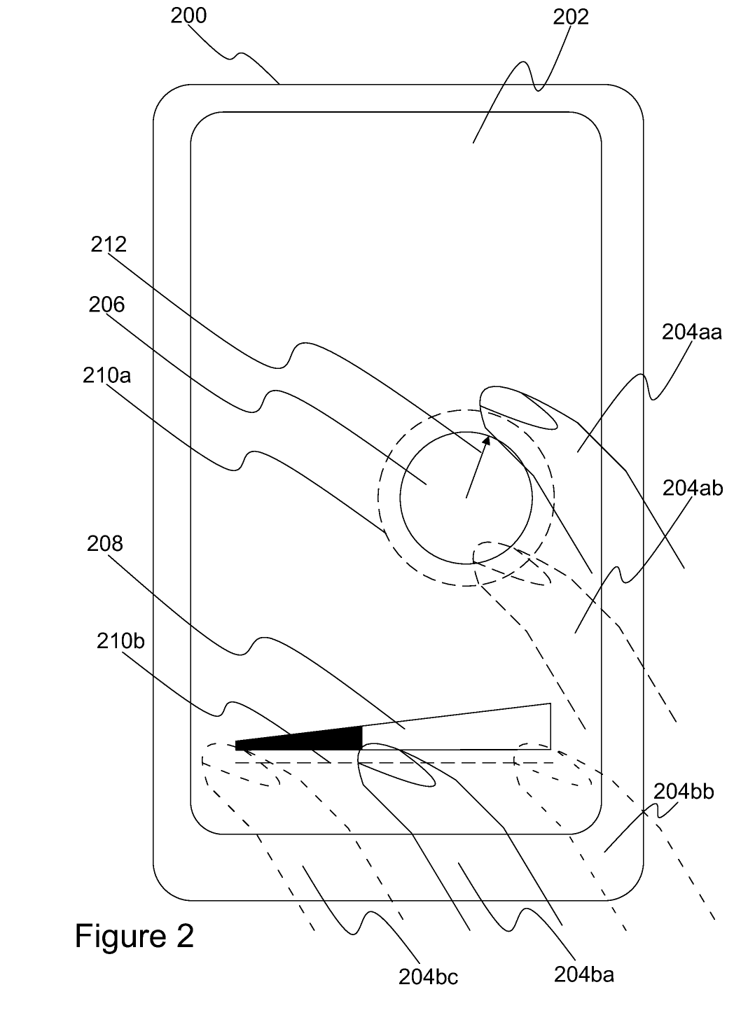

With reference to FIG. 2, exemplary configurations of graphical indications 206, 208, 212 and user input gestures of an embodiment of an electronic device 200 in accordance with the present invention are illustrated.

The illustration depicts the device 200, which comprises a touch screen 202 and exemplary graphical indications 206, 208. The graphical indications 206, 208 are merely exemplary and depend on the configuration. Preferably one graphical indication 206, 208 is used at a time. Optionally no graphical indications 206, 208 are used. The graphical and/or textual indications 206, 208 may comprise tagging, highlighting, outlining, coloring, text or a number of letters, numbers, alphanumeric markings, and/or graphics, e.g. curves or lines, and/or other markings of the area or path.

Means of engendering user input, such as static touch and/or movement, may comprise one or more fingers, another similarly suitable anatomical part and/or by stylus. Further on, the user input may comprise one or more input means being provided simultaneously on any of the input areas.

The illustration depicts also the user input gesture path 210a, 210b in relation to the optional graphical indications 206, 208. An input means such as a finger 204aa, 204ba may so be used for engendering user input gesture, in relation to a graphical indication 206, 208 or to a path 210a, 210b. Hence, it is clear that the same paths for translating the user input into adjustment action via the magnitude and direction may be produced anywhere on the touch screen 202 and needn't be tied to a graphical indication 206, 208. However, essentially defining a path, even when not graphically visualized via the GUI, is a prerequisite for engendering the adjustment user input because it defines the direction and scale of the user input gesture and the according adjustment action.

The user input gesture is achieved by moving the finger 204ab, 204ba along or in relation to a path 210a, 210b. For example, when using a path of 210b, moving finger 204ba to the position of 204bb may be translated as to increase the value of the adjustable parameter whereas moving it to the position of 204bc may be translated as to decrease the value of the adjustable parameter, or vice versa. Herein the graphical indication 208 may comprise for example a meter for visualizing the value of the parameter. Optionally the user input gesture may comprise using the path of 210a comprising moving input means from 204aa to 204ab for example in a curved manner, wherein the graphical indication 206 may comprise a suitable meter such as a knob or gauge depicting the current value of the parameter for example on a scale with an arrow 212. Indeed, a myriad of usable meter and gauge types for visualization purposes are feasible.

Other exemplary visualizations comprise any graphics such as circular and/or line graphics, optionally representing indicators and/or other visualizations e.g. of a meter showing the measure of the adjustable parameter and/or of a control device such as a slide (knob), a (rotary) control knob, a push knob, a curve slide (knob) or a lever. A GUI control device may comprise also thumb menu type adjustment indicator and control device, easily accessible and operable with thumb while e.g. holding the device 200 on hand. Further on, such graphical user interface visualizations may comprise indicators and/or control devices analogous with common hardware indicators and control devices that respond and are usable by input means in the same manner as their analogous hardware counterparts. For example, a GUI control knob 206 (virtual knob rendered on the display) may be turned via a user gesture and it may also represent the value via a scale around the knob, wherein the degree of rotation would correspond to the desired input and/or adjustment. Hence, any such control device means and indicators may be graphically visualized and used together with the present invention.

The visualizations and the underlying paths in relation to which the user input gestures are translated may be scaled and/or direction-wise configured and displayed. For example, turning a knob clockwise may produce an increase in the capture rate or vice versa. Following the same example, the rotation may be scaled so that a one step, for example if the rotation of the knob is divided into ten steps, may produce a change in rate of capture of 0.1 frames per second, or 0.5, 1, 2, 4, 6 or 8 frames per second. Optionally the scale may be divided so that it comprises the whole possible scale in which the rate of capture may be changed, such as for example dividing the rotation scale evenly so that the rate of capture may be changed from 1 to 120 frames per second. Optionally the scale may be divided so that it comprises the whole possible scale in which the rate of capture may be changed, such as that the rotation scale is divided unevenly optionally so that the lower rates are less sensitive (scale is wider in the beginning), which makes it easier to change smaller frame rates with greater accuracy, said smaller frame rates being for example from 1 to 24 frames per second. Correspondingly, similar scaling and direction-magnitude technique may be used with other graphical indications and control devices. For example, a slide may produce an increase in capture rate when moved to the right and vice versa. Using the same example, the slide may have a visualizing indicator such as a bar or a gauge that indicates the whole scale of possible capture rates. Both indicators 206, 208 and graphical control functions are merely exemplary but they propose beneficial embodiments from the viewpoint of usability as both of them are usable with for example one finger.

The movement in relation to a path is free allowing the user to increase and/or decrease according to their wishes during the imaging. The movement may so comprise moving horizontally, vertically and/or in any direction between horizontal and vertical directions including a curved path, optionally with a path having a plurality of directions, optionally relative to provided GUI graphical indications 206, 208. Typically, when the user input gesture is provided via touch screen 202, the gesture is provided relative to a two-dimensional plane defined by the surface of the touch screen 202.

As also mentioned hereinbefore, the user input gestures may be optionally provided in any location of the touch screen 202 wherein the user input gesture is translated into an adjustment action by the direction and magnitude of the user input gesture in relation to a path. The user input gesture may comprise touch-based or contactless gesture in relation and/or contact with the touch screen 202, wherein said gesture types are dependent on the technology of the touch screen 202. Optionally additionally the pressure against a touch-based touch screen or the perpendicular movement in relation to a three-dimensional touch screen may be used for producing an adjusting configuration. Such configuration may resemble and the optional graphical indications 206, 208 representing such function may be essentially analogous with a push control knob, optionally being substantially continuously variable.

Hence, a path as meant herein is to be understood not only as two-dimensional along and/or in relation to the touch screen 202 surface (as explicitly depicted) but as optionally comprising the push movement as well, i.e. variation of the pressure or moving perpendicularly in relation to the touch screen 202 surface.

As mentioned the depicted paths and indicators are exemplary and comprise various different embodiments, achievable via adjustable and changeable computing entity configurations.

Additionally or alternatively, the pace of the gesture may change from astatic state to a relatively rapid movement, and various different paces in between. Beginning or end of a gesture may be detected, for example, from a rapid introduction or loss of pressure, or generally input means, respectively on a touch-sensitive surface.

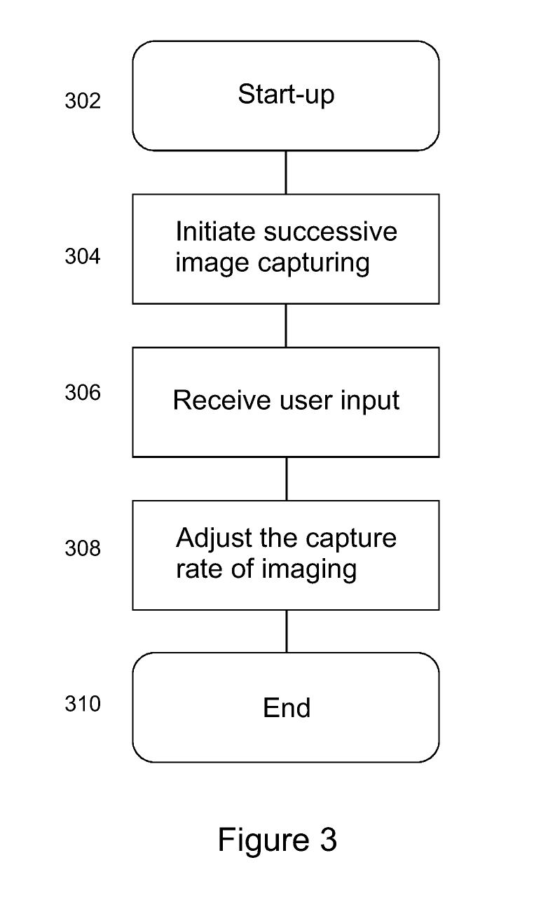

With reference to FIG. 3, a flow diagram of an embodiment of a method for adjusting capture rate of successive imaging function through an electronic device in accordance with the present invention is shown.

At 302, referred to as the start-up phase, electronic device executing the method is at its initial state. At this initial phase the computing entity is ready to detect and act on user input via the graphical user interface. Optionally, the initial capture rate and other imaging parameters, such as exposure, aperture, focusing, light metering and/or white balance, may be adjusted. Optionally additionally, the frame rates at which the imaging changes between successive image capturing and capturing video, and the rate at which slow-motion video capturing is initiated may be determined, optionally according to user input.

At 304, the successive image capturing function, such as a burst mode imaging function, is initiated. The successive image capturing may have an initial capture rate of substantially 3 or less frames per second or 4, 6, 8 or 10 frames per second, or another rate of frames per second.

At 306, user input is received. Optionally the user may be inquired to confirm that the user input is translated as the adjustment intended by the user.

At 308, the user input is translated into an adjustment essentially of at least the capture rate of the successive image capturing function. The capture rate may be changed into any number of frames per second from example in the range of 0.1-120 or to any other feasible number of rates per second according to the possible digital camera capabilities and user input. Additionally, the user input may be translated into adjusting other imaging features as well, such as exposure, aperture, focusing, light metering and/or white balance. In addition, images and/or optional videos may be processed and/or combined.

Optionally the adjustment may lead to a shift in the imaging mode, e.g. in accordance to the capture rate. Shifting from successive image capturing to capturing video may be done at substantially e.g. 10 frames per second or 12, 14, 16, 18, 20, 22, 24 or e.g. 30 frames per second, or basically any other technically feasible number of frames per second. Shifting from capturing video to capturing slow-motion video may be done at substantially at 24 frames per second or at a higher frame rate. Optionally the computing entity may be configured to inquire if the user would like to shift from successive image capturing to capturing video, optionally graphically and/or textually.

At 310, referred to as the end phase, the user terminates the successive image capturing function and the method ends. Optionally the computing entity may be configured to terminate the successive image function.

The phases 306 and 308 are carried out essentially simultaneously and may be repeated as many times as the user wishes and/or before the user terminates the successive image capturing function and ends the method.

The invention may be embodied as a software program product that may incorporate a similar suitable electronic device to the one presented herein. The software program product may be offered as software as a service (SaaS). The software program product may include and/or be comprised e.g. in a cloud server or a remote terminal or server.

The scope of the invention is determined by the attached claims together with the equivalents thereof. The skilled persons will again appreciate the fact that the disclosed embodiments were constructed for illustrative purposes only, and the innovative fulcrum reviewed herein will cover further embodiments, embodiment combinations, variations and equivalents that better suit each particular use case of the invention.

1. An electronic device, comprising:
a touch screen,
a digital camera,
a computing entity configured to display graphical user interface via said touch screen, and configured to capture user input via said graphical user interface, and configured to utilize digital camera for digital imaging, the computing entity being specifically configured to:
initiate a successive image capturing function via said digital camera;
detect substantially continuous user input gesture via said graphical user interface, optionally upon graphical indications; and
adjust the capture rate of said successive image capturing function according to said user input gesture.

2. The device according to claim 1, wherein the successive image capturing function is a burst mode function.

3. The device according to claim 1, wherein the computing entity is configured to shift from successive image capturing to capturing video at a predetermined capture rate.

4. The device according to claim 1, wherein the user input gesture is used to adjust features such as exposure, aperture, focusing, light metering and/or white balance, optionally in accordance to the capture rate.

5. The device according to claim 1, wherein the substantially continuous user input comprises essentially horizontally, vertically and/or circularly free movement upon the touch screen, optionally upon and/or in relation to graphical indications.

6. The device according to claim 1, wherein the graphical indications may comprise circular, curves and/or line graphics.

7. The device according to claim 1, wherein the substantially continuous user input gesture direction and magnitude are defined according and/or in relation to a predefined path.

8. The device according to claim 1, comprising or constituting a mobile terminal, optionally a smartphone.

9. The device according to claim 1, comprising or constituting a desktop or a laptop computer.

10. The device according to claim 1, comprising or constituting a tablet or phablet computer.

11. The device according to claim 1, comprising or constituting a digital camera, optionally an add-on, time-lapse, compact, DSLR, DSLT or high-definition personal camera.

12. A method for adjusting the capture rate of said successive imaging through an electronic device, comprising:
receiving substantially continuous user input provided as a gesture on a graphical user interface via the touch screen,
detecting the movement direction and magnitude of the user input gesture, and
adjusting the capture rate of the successive imaging function according to the direction and magnitude of the user input gesture.

13. The method according to claim 12, wherein the user input gesture magnitude is defined by the distance that the user input gesture traveled on/along or against the graphical user interface.

14. The method according to claim 12, wherein the user input gesture may change movement direction during said user input gesture.

15. A computer program product embodied in a non-transitory computer readable medium, comprising computer code for causing the computer to execute:
receiving substantially continuous user input provided as a gesture on a graphical user interface via the touch screen,
detecting the movement direction and magnitude of the user input gesture, and
adjusting the capture rate of the successive imaging function according to the direction and magnitude of the user input gesture.
